(19) United States
(12) Patent Application Publication
(10) Pub. No.: US 2022/0343043 A1
(43) Pub. Date: Oct. 27, 2022

(54) OPTIMIZING MIXING TOOLS USING MODELING AND VISUALIZATION

(71) Applicant: 3M INNOVATIVE PROPERTIES COMPANY, St. Paul, MN (US)

(72) Inventors: Dong Fu, Woodbury, MN (US); Gustavo H. Castro, Woodbury, MN (US); Kent E. Lageson, Prior Lake, MN (US); Thomas G. Skulley, St. Paul, MN (US); Christopher M. Brown, Cottage Grove, MN (US); Lori A. Sjolund, Stillwater, MN (US); Jon A. Kirschhoffer, Stillwater, MN (US); Yehuda E. Altabet, Sharon, MA (US); Gary G. Uebel, River Falls, WI (US)

(21) Appl. No.: 17/755,588

(22) PCT Filed: Nov. 24, 2020
(86) PCT No.: PCT/IB2020/061085

§ 371 Date: May 3, 2022

Related U.S. Application Data
(60) Provisional application No. 62/940,613, filed on Nov. 26, 2019.

(51) Int. Cl. G06F 30/28; G06F 30/25; G06F 30/12

(52) U.S. Cl. CPC G06F 30/28; G06F 30/25; G06F 30/12; G06F 2113/08

(57) ABSTRACT

Systems and methods for designing and optimizing tools are provided. A computational fluid dynamics (CFD) simulation model implemented by a processor is provided to simulate a fluid flow inside the tool to generate a particle density distribution of fluids inside the tool. The particle density distribution is converted to a spatial distribution of fluid concentration of the mixture which allows for high resolution visualization of fluid flow in the tool.

### BACKGROUND

Mixing tools such as mixers or blenders for adhesives and sealants are widely used. Mixers are commercially available for two-part adhesives. A static or dynamic mixer is a precision engineered device for the continuous mixing of fluid materials, without or with moving components. Normally the fluids to be mixed are liquid, but mixers can also be used to mix gas streams, disperse gas into liquid or blend immiscible liquids. The energy needed for mixing comes from a loss in pressure as fluids flow through the static mixer. One design of mixer is a plate-type mixer and another common device type consists of mixer elements (e.g., a rotating screw) contained in a cylindrical (tube) or squared housing.

### SUMMARY

There is a desire to optimize mixing tools to improve the mixing performance and quality, as well as minimizing waste. The present disclosure provides systems and methods for optimizing and designing mixing tools using modeling and visualization.

In one aspect, the present disclosure describes a method of optimizing a mixing tool to mix a plurality of fluid materials to obtain a mixture. The method includes representing a first geometry of the mixing tool with a first digital three-dimensional (3D) model; providing the first digital 3D model to a computational fluid dynamics (CFD) simulation model implemented by a processor to simulate a mixing process of the plurality of fluids to generate a particle density distribution of the mixture inside the mixing tool; converting the particle density distribution of the mixture to a first spatial distribution of fluid concentration of the mixture; measuring a second spatial distribution of fluid concentration of the mixture inside the mixing tool when mixing the plurality of fluids using the mixing tool; and comparing the first and second spatial distributions of fluid concentration to determine whether the first and second spatial distributions match with each other.

In another aspect, the present disclosure describes a computer-implemented method to design and optimize a tool. The method includes representing a first geometry of the tool with a first digital 3D model; providing the first digital 3D model to a computational fluid dynamics (CFD) simulation model implemented by a processor to simulate a fluid flow inside the tool to generate a particle density distribution of one or more fluids inside the tool; converting the particle density distribution to a spatial distribution of fluid concentration of the mixture; and visualizing the spatial distribution of fluid concentration and a measured spatial distribution of fluid concentration in a graphic user interface (GUI)

In another aspect, the present disclosure describes a computer-implemented system to design and optimize a tool. The system includes a module to represent a first geometry of the tool with a first digital 3D model; a module to provide the first digital 3D model to a computational fluid dynamics (CFD) simulation model implemented by a processor to simulate a fluid flow inside the tool to generate a particle density distribution of one or more fluids inside the tool; a module to convert the particle density distribution to a spatial distribution of fluid concentration of the mixture; and a module to visualize the spatial distribution of fluid concentration and a measured spatial distribution of fluid concentration in a graphic user interface (GUI).

Various unexpected results and advantages are obtained in exemplary embodiments of the disclosure. One such advantage of exemplary embodiments of the present disclosure is that the systems and methods can carry out multiple comparisons for tool design and optimization through high-definition visualizations of simulation data.

The performance of adhesives depends on the mixing quality in the dispensing process of multiple parts. The mixer tip design is critical for achieving a targeted mixing performance as well as minimizing both waste and the pressure drop during dispensing. The methods and systems described herein can also apply to other mixing systems with relatively high viscosity such as sealant mixing, dental adhesive, etc.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1A is a flow diagram of a method 100 of designing and optimizing a mixing tool, according to one embodiment.

FIG. 1B is a diagram of a system for designing and optimizing a mixing tool, according to one embodiment.

FIG. 2 is a flow diagram of a method of validating a model for a mixing tool, according to another embodiment.

FIG. 3A is a schematic diagram showing a digital 3D simulation of mixing two fluids in a mixing tool, according to one embodiment.

FIG. 3B is a schematic diagram showing a digital 3D simulation of mixing two fluids in a mixing tool, according to one embodiment.

FIG. 3C is a screenshot of a digital 3D visualization of particle density distribution from the digital 3D simulation of FIG. 3B.

FIG. 3D is a schematic diagram of a portion of the digital 3D simulation of FIG. 3B, according to one embodiment.

FIG. 4 illustrates plots of mixing index M_{P} versus the local weight fraction f₁ for an exemplary mixture having a target mixing ratio of N₁:N₂=2:1.

FIG. 5A is a cross sectional view of a mixing index distribution in a digital 3D model of a mixing tool, according to one embodiment.

FIG. 5B is a cross sectional view of a simulated fluid concentration for fluid B in the digital 3D model of FIG. 5A.

FIG. 5C is a cross sectional view of a measured fluid concentration for fluid B from a particle laden experimental CT-scan.

FIG. 6A is a cross sectional view of a mixing index distribution in a digital 3D model of a mixing tool, according to one embodiment.

FIG. 6B is a cross sectional view of a simulated fluid concentration for fluid B in the digital 3D model of FIG. 6A.

FIG. 6C is a cross sectional view of a measured fluid concentration for fluid B from a particle laden experimental CT-scan.

FIG. 7 illustrates plots of mixing index versus distance under different RPM for a dynamic mixer.

FIG. 8 illustrates plots of mixing index versus distance under different RPM for different designs of a dynamic mixer.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

Systems and methods for designing and optimizing tools are provided. A computational fluid dynamics (CFD) simulation model implemented by a processor is provided to simulate a fluid flow inside the tool to generate a particle density distribution of one or more fluids being mixed inside the tool. The particle density distribution is converted to a spatial distribution of fluid concentration of the mixture, and visualized in a graphic user interface (GUI) to allow for high resolution visualization of any spatially resolved discontinuous variable of fluid flow in the tool.

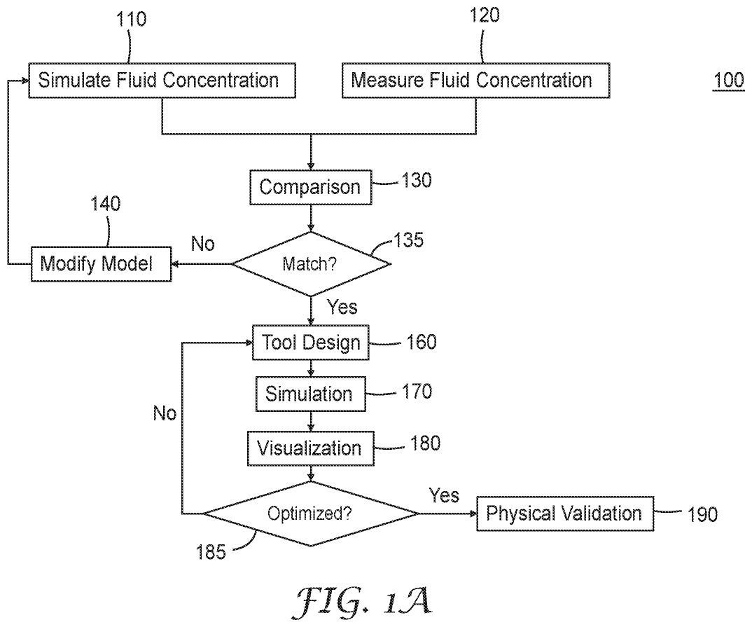

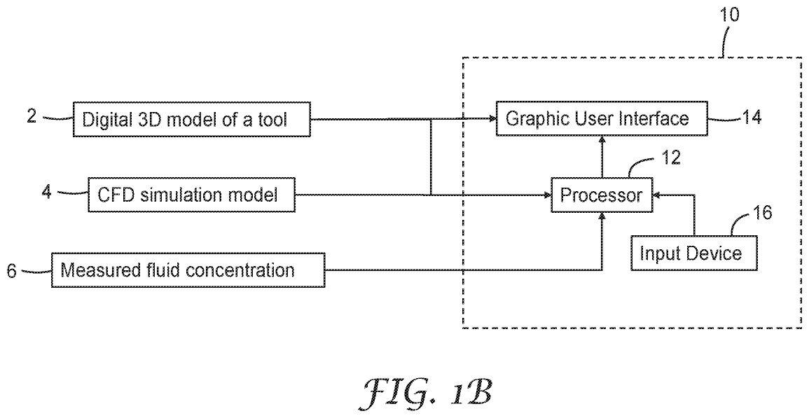

FIG. 1A is a flow diagram of a method 100 of designing and optimizing a mixing tool, according to one embodiment. The method 100 can be used for optimizing mixing tools or developing new mixing tools for new adhesives that require desired mixing to achieve optimized performances. The resulting mixing tools can obtain new or enhanced mixing properties including, e.g., higher uniformity, less uncured spots, lower pressure drop, less material waste, reactive interface material with higher strength, etc.

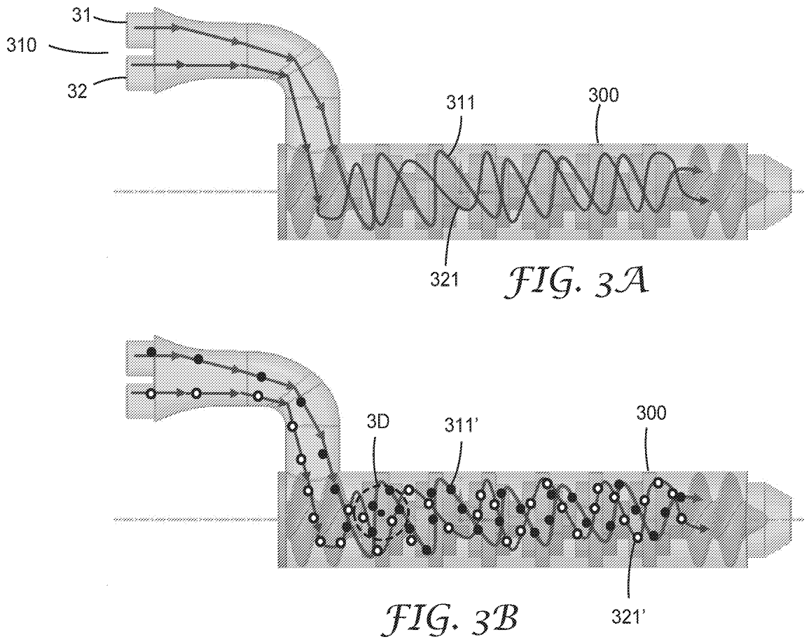

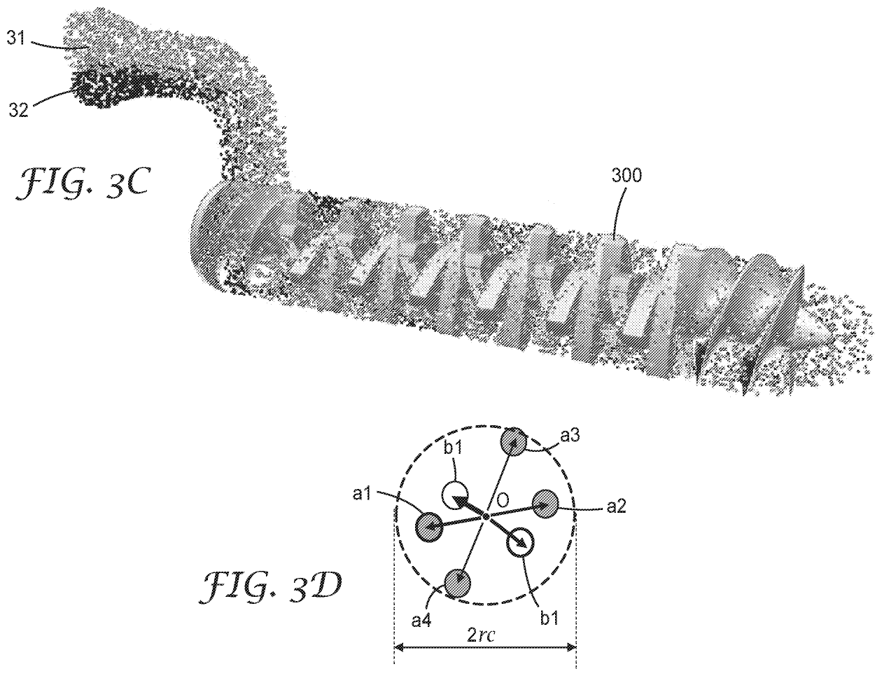

At 110, a computation fluid dynamics (CFD) simulation model can be implemented by a computing device such as, for example, a processor, to simulate a mixing process of multiple fluids inside any given mixing tool. A geometry of the mixing tool can be represented by a digital three-dimensional (3D) model. The digital 3D model can be in the form of an electronic file for computer-aided design (CAD), computer-aided manufacturing (CAM), computer-aided engineering (CAE), or other suitable applications. One exemplary digital 3D model of a mixing tool is visualized in a graphic user interface shown in FIG. 3C.

The digital 3D model of the mixing tool can be provided, along with other simulation model parameters, to the computer-implemented simulation method to simulate the process of mixing fluid materials to form a mixture by the mixing tool. The simulation results can be further processed to generate a spatial distribution of fluid concentration of the mixture. A spatial distribution of fluid concentration described herein refers to the quantity of a given type of fluid occupying a unit volume. The simulation model parameters for the CFD simulation model may include, for example, mesh density, time step, etc.

At 120, a physical mixing tool can be provided having the same geometry as that for the CFD simulation model at 110. Fluid materials can be mixed by the mixing tool under the same operation conditions for the simulation at 110 including, for example, the same rotational speed (RPM) of an internal rotating screw, the same fluid flow rates, etc. The spatial distribution of fluid concentration of the mixture can be physically measured for the mixture inside the mixing tool. One exemplary method is to use particle laden experimental CT-scan to measure fluid concentrations. The method 100 then proceeds to 130.

At 130, the simulated spatial distribution of fluid concentration from 110 and the measured spatial distribution of fluid concentration from 120 can be compared to determine whether the two spatial distributions match with each other at 135. When the two spatial distributions match with each other, the CFD simulation model at 110 can be validated and the method 100 proceeds to 160. When the two spatial distributions do not match with each other, the computation fluid dynamics (CFD) simulation model is modified and the method 100 proceeds back to 110. For example, the simulated and measured spatial distributions can be respectively visualized, e.g., being represented by iso-surfaces which can be overlaid in a graphic user interface (GUI). When the respective shapes and distributions of the iso-surfaces match with each other, the CFD simulation model at 110 can be validated. When the respective shapes and distributions of the iso-surfaces do not match with each other, the CFD simulation model can be modified at 140 and the method 100 proceeds back to 110 until the simulated and measured spatial distributions match with each other and the CFD simulation model is validated. Then the method 100 proceeds to 160.

At 160, a tool can be designed, and its geometry can be represented by a digital 3D model. Then, at 170, the validated CFD simulation model can be applied to the designed tool, and the process of mixing fluid materials to form a mixture can be simulated via a computing device. The simulation results can be further processed to generate data related to a fluid concentration distribution of the mixture, which can be visualized at 180. By reviewing the visualized data, a user can determine at 185 whether the designed tool meet the target performance, e.g., whether the fluid materials are uniformly mixed by the designed cool according to the simulation results. When the target performance is reached, the design is optimized and the method 100 proceeds to 190. When the target performance is not reached, the method 100 proceeds back to 160 to keep optimizing the tool design. At 190, a physical tool according to the optimized design is made, and its physical performance can be measured by, e.g., standard peel test, shear test, etc., to physically validate the tool.

FIG. 1B is a block diagram of a system 10 for implement a method of designing and optimizing a tool, e.g., a mixing tool. The system 10 includes a processor 12 to receive a first digital 3D model 2 which represents a first geometry of the tool. The processor 12 further implements a module to provide the first digital 3D model 2 to a computational fluid dynamics (CFD) simulation model implemented by a processor to simulate a fluid flow inside the tool to generate a particle density distribution of one or more fluids inside the tool, implements a module to convert the particle density distribution to a spatial distribution of fluid concentration of the mixture, and implements a module to visualize the spatial distribution of fluid concentration and a measured spatial distribution of fluid concentration 6 in a graphic user interface (GUI) 14. The graphic user interface (GUI) may include a computer screen, an immersive virtual reality (VR) device, etc. The system further includes an input device 16 to receive instructions or input from a user and interact with the user.

The processor 12 can be included in any computing device. The processor 12 may include, for example, one or more general-purpose microprocessors, specially designed processors, application specific integrated circuits (ASIC), field programmable gate arrays (FPGA), a collection of discrete logic, and/or any type of processing device capable of executing the techniques described herein. In some embodiments, the processor (or any other processors described herein) may be described as a computing device. In some embodiments, the memory may be configured to store program instructions (e.g., software instructions) that are executed by the processor to carry out the processes or methods described herein. In other embodiments, the processes or methods described herein may be executed by specifically programmed circuitry of the processor. The processor may thus be configured to execute the techniques for any simulation and analysis described herein. The processor (or any other processors described herein) may include one or more processors.

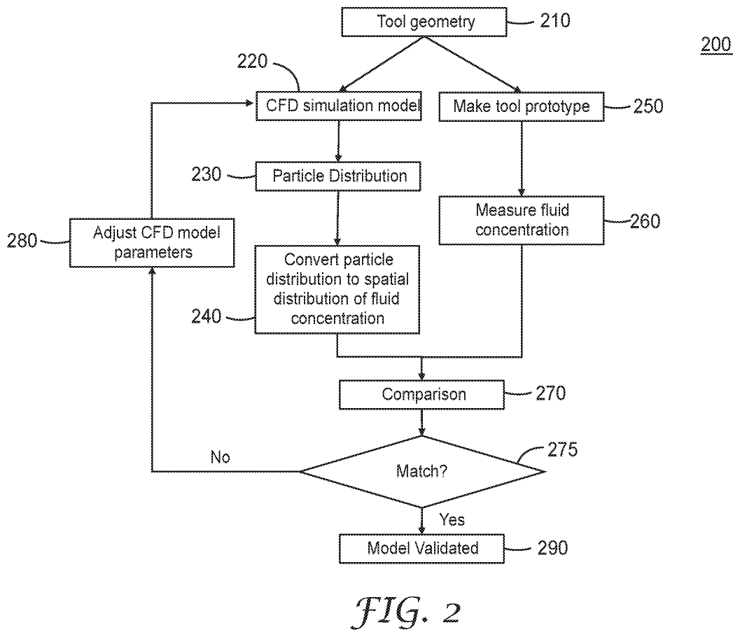

FIG. 2 is a flow diagram of a method 200 of validating a model for a mixing tool, according to another embodiment. The method 200 can validate a computation fluid dynamics (CFD) simulation model for a mixing tool. After the CFD simulation model is validated, the model can be applied to optimize the design for any suitable tools. It is to be understood that the method 200 can be combined with any method of optimizing a tool described herein, such as, for example, the method 100 of FIG. 1A.

At 210, a tool design with a given geometry is provided. The tool geometry can be represented by a digital 3D model. The tool geometry can be provided to a computation fluid dynamics (CFD) simulation model at 220 to simulate the process of mixing multiple fluid materials or species to generate a particle density distribution of the mixture at 230.

The CFD model described herein utilizes a particle mixing model that tracks weight-less particles in different components of the mixture of multiple fluids. Input for the particle mixing model includes the spatial coordinates of discrete tracer particles (or fluid representing particles) of the respective fluid species (e.g., a mixture including fluid species or parts A and B). In other words, a space distribution of a finite number of fluid representing particles (or tracer particles) is utilized to represent the continuous fluids to be mixed.

Numerical diffusion can be avoided in the particle mixing model as compared to a scalar mixing model. A typical scalar mixing model was described in, for example, Alméras, E., Plais, C., Euzenat, F., Risso, F., Roig, V. and Augier, F., 2016, Scalar mixing in bubbly flows: Experimental investigation and diffusivity modelling, Chemical Engineering Science, 140, pp. 114-122. The scalar mixing model solves passive scalar transport equation(s) for each type of fluid to obtain the concentration of each fluid. One problem accompanying the scalar mixing model is that the numerical method to solve such equation(s) will introduce error called numerical diffusion which results in overestimation of mixing quality compared to the reality. The particle mixing model applied herein can overcome the challenges by tracking the coordinates of fluid representing particles according to the fluid velocity field. In general, the particle mixing model is more accurate than the scalar mixing model by avoiding the problem of numerical diffusion.

FIGS. 3A-B illustrate a digital 3D simulation of mixing two fluid materials in a digital 3D model 300 of a mixing tool using a particle mixing model, according to one embodiment. The fluid materials 31 and 32 are provided into the inlet 310. The digital simulation first generates the flow velocity distributions for the fluid materials 31 and 32, which are shown as streamlines 311 and 321 for the fluid materials 31 and 32, respectively. Then a finite number of “fluid representing particles” 311′ or 321′ can be used to represent the respective fluids 31 and 32, as shown in FIG. 3B. The trajectory of the fluid representing particles 311′ or 321′ follow the respective streamlines 311 and 321 of FIG. 3A. Using this method, the locations of the fluid representing particles in the mixture can be calculated with the simulation of mixing the fluid materials inside the mixing tool. FIG. 3C is a screenshot of a digital 3D visualization of the particle density distributions for fluid materials 31 and 32 inside the digital 3D model 300 of the mixing tool, resulting from the digital simulation of FIG. 3B.

A particle density distribution described herein refers to the distributions or locations of each fluid representing particle inside the mixing tool at a given time. The number of fluid representing particles depends on the mesh density (number of cells) of the CFD model. Usually the number of fluid representing particles is one order of magnitude lower than the number of cells used for the CFD model. The typical number of cells can be, for example, about 2 million or more in a 3D configuration of a tool. The computational time increases exponentially with the number of fluid representing particles used for a simulation. Thus, the number of fluid representing particles is limited by computational resources.

Referring again to FIG. 2, the particle density distribution of the mixture 230 obtained from the CFD simulation model 220 can be converted to a spatial distribution of fluid concentration of the mixture at 240. FIG. 3D is a schematic diagram of a portion of the digital 3D simulation of FIG. 3B, illustrating how to convert a particle density distribution of a mixture to a spatial distribution of fluid concentration of the mixture. The value of fluid concentration at a given point (e.g., point O in FIG. 3D) of the simulation domain can depend on the location of each adjacent fluid particle (e.g., particles a1, a2, a3 and a4 of fluid material 31 and particles b1 and b2 for fluid material 32). The fluid concentration at any given point of the simulation domain (e.g., inside the mixing tool 300) can be calculated by weighting nearby particles by, e.g., a decay function. In other words, particles of one fluid material closer to a given point can contribute more than particles further away from that point regarding the local fluid concentration of that fluid material. The conversion can take discrete fluid representing particle positions and calculate a physically reasonable concentration of fluid species at any point in the simulation domain. In this manner, the discretized particle location (i.e., the particle density distribution) can be mapped to a continuous fluid concentration space (i.e., the spatial distribution of fluid concentration).

One exemplary conversion method uses a spatial coarse-graining of the particle density field. In other words, the method takes a set of points and provides them with some volume to better approximate the fluid elements they are supposed to represent. This is achieved through convolution of a particle's position with a reasonably chosen coarse graining function. The local concentration cₐ(r) can then be calculated through Equation (1) below:

c_{α}(r)=Σᵢ₌₁^{N}^{_{α}}(rᵢ−r) (1)

Where rᵢ is the position of the i-th particle of specie a and Na is the number of such particles. One embodiment employs a Gaussian as the coarse-graining function as shown in Equation (2) below:

$$ϕ ( {r}_{i} - r ) = exp ( - \frac{{\vert {r}_{i} - r \vert}^{2}}{2 σ} ) \qquad ( 2 )$$

In this case, a is a coarse-graining length scale, which sets how much volume the particle is intended to occupy. In addition, to enable more efficient computation, the Gaussian is truncated and shifted to zero at a specified cut-off r_{c} and then normalized. FIG. 3D illustrates the particles a1-a4 and b1-b2 within the cut-off r_{c} that are counted for calculating the local concentration ca(r). In one example, σ=0.6 mm and r_{c}=1.2 mm. In a particle mixing model for simulating the process of mixing adhesive fluids, the coarse-graining length scale σ may be in the range of 0.1 mm to 2.0 mm. The specified cut-off r_{c}=2σ may be in the range of 0.2 mm to 4.0 mm. The value of σ relates to the visualization resolution. A smaller value of a means a higher resolution. The value of σ is chosen to be larger than the cell size used in the CFD calculation.

While a Gaussian coarse-graining function is used in Equation (2) to weight the contribution from nearby particles while converting a particle density distribution of the mixture to a spatial distribution of fluid concentration of the mixture, it is to be understood that any suitable decay function can be used to weight the contribution from nearby particles, including, for example, linear functions, polynomial functions, etc.

Referring again to FIG. 2, the tool geometry at 210 can also be provided to make a physical tool prototype at 250. The physical tool prototype can be made by any suitable processes such as, for example, a three-dimensional (3D) printing process. At 260, fluid concentrations for one or more species of the mixture inside the physical tool prototype can be measured when the mixture is still inside the tool. Various experimental methods and systems can be used to measure the fluid concentration when multiple species of fluid are mixed inside a mixing tool. In some embodiments, a particle laden experimental CT-scan is provided to quantify the detailed mixing process inside the mixing tool. Tracking particles, such as inert metal particles having higher densities than the fluids, can be added to one or more species to track the fluid flow inside the mixing tool.

In one example, copper metal flakes with particle size 325 Mesh (44 microns and finer) was premixed with one part of the adhesive with volume fraction of less than 2%. Then, the mixing experiment of the two-part adhesive using different mixer tip was carried out. After the experiment, the filled mixer tip is CT-scanned. Due to the high density of the copper comparing to the adhesive material, the part with the copper particle can show higher density in the CT-scan. By analyzing the density intensity of the CT-scan image, the detailed mixing process can be obtained. For well mixed regions, the density intensity is similar throughout the space. For example, at the exit of the mixing tool where the species are well mixed, a substantially uniform density intensity is shown. For poorly mixed regions, the density intensity has a large spatial variation. For example, near the inlet of the mixing tool, a substantially non-uniform density intensity can be shown.

Referring again to FIG. 2, at 270, the spatial distribution of fluid concentration obtained at 240 and the fluid concentration measured at 250 can be compared, e.g., by visualization. For example, the simulated and measured spatial distributions can be respectively represented by iso-surfaces which can be overlaid in graphic user interface (GUI). By reviewing the overlaid iso-surfaces, a user can determine at 275 whether the two spatial distributions match with each other. It is to be understood that the spatial distributions can be visualized by any suitable digital image representations other than iso-surfaces. Suitable digital image representations may include, for example, contours, particle path-lines, etc.

When the two spatial distributions match with each other, the CFD simulation model at 220 can be validated at 290. When the two spatial distributions do not match with each other, the computation fluid dynamics (CFD) simulation model is modified at 280 and the method 200 proceeds back to 220. Modifying a CFD simulation model may include, for example, varying simulation parameters including mesh density, time steps, etc.

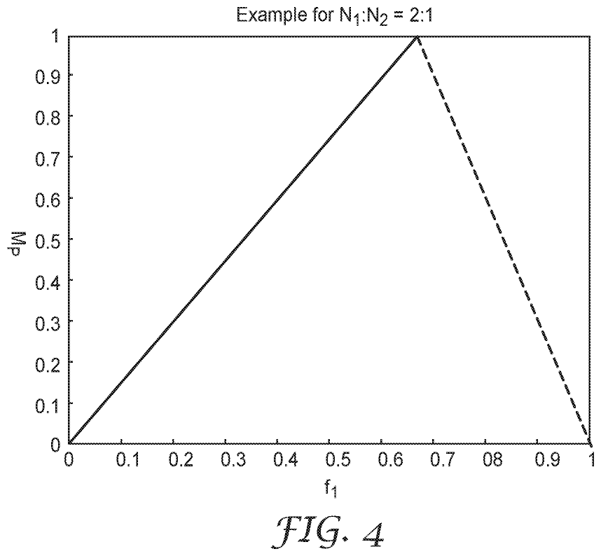

The obtained local fluid concentration cₐ(r) at 240 can be further processed to calculate a spatially resolved mixing index M_{P}(r) that can easily be visualized to assess mixing performance. The local mixing quality depends on the respective fluid concentration distributions of the components (species) of the mixture. For example, for a binary mixture with a concentration ratio between the two components or species of N₁:N₂, a mixing index can be defined by Equation (3):

$${M}_{p} = \{ \begin{matrix}1 + \frac{{f}_{1} - {f}_{1}^{t}}{{f}_{1}^{t}} & {f}_{1} \leq {f}_{1}^{t} \\ 1 - \frac{{f}_{1} - {f}_{1}^{t}}{1 - {f}_{1}^{t}} & {f}_{1} > {f}_{1}^{t}\end{matrix} \qquad ( 3 )$$

where f₁^{t} is the target well mixing fraction of specie 1. The local weight fraction of specie 1 is defined as f₁=c₁(c₂+c₁), where c₁ and c₂ being the respective concentrations of species 1 and 2. The value of mixing index Mₚ varies between 0 and 1, where the value of 1 refers to a state of mixture being mixed to target proportions and the value of 0 refers to pure species. FIG. 4 illustrates plots of mixing index M_{P} versus the local weight fraction f₁ for an exemplary mixture having a target mixing ratio of N₁:N₂=2:1.

Computer-implemented computational methods and systems are developed herein to determine the mixing quality as represented by, e.g., the mixing index M_{P}(r), at desired locations within a mixing tool based on the obtained local fluid concentration cₐ(r). It is to be understood that the mixing index M_{P}(r) and the local fluid concentration cₐ(r) can be derived from each other for one or more specifies of the mixture. The spatial distribution of mixing index can be visualized in the graphic user interface (GUI), along with a spatial distribution of fluid concentration.

### EXAMPLES

### Example 1: A Static Mixer

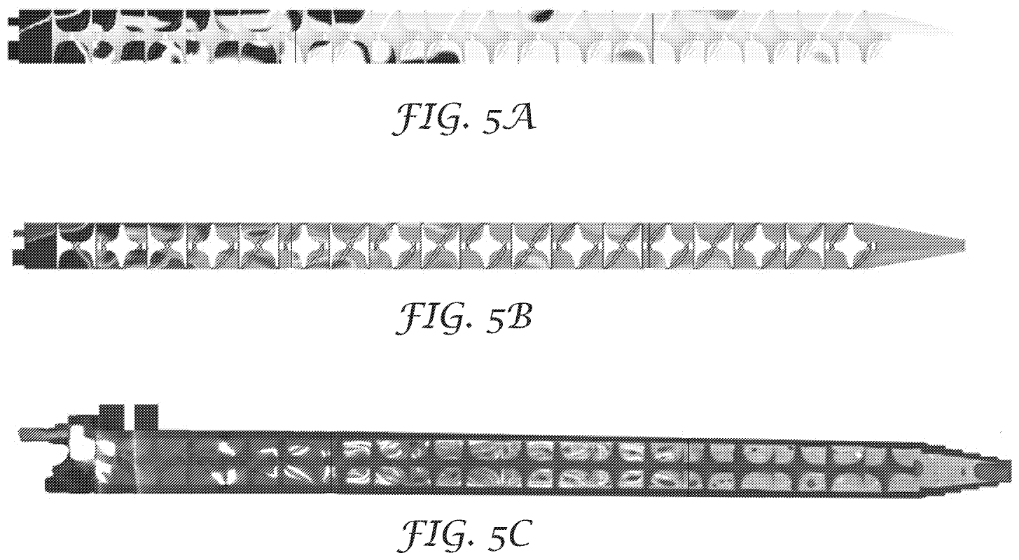

A static mixer was used to validate a computational fluid dynamics (CFD) simulation model. The geometry of the static mixer was created via a CAD file. The CAD file was input to the CFD model for simulation of mixing fluid A and fluid B to form a mixture. Fluid A is 3M Scotch-Weld low odor acrylic adhesive accelerator part (reference DP 8810NS Green) with a viscosity of 35000 cP and density of 1.08 g/cc. Fluid B is 3M Scotch-Weld low odor acrylic adhesive base part (reference DP8810NS Green) with a viscosity of 90000 cP and density of 1.08 g/cc. The mix ratio by volume and weight is 10 part Fluid A: 1 part Fluid B. The CFD model is a particle mixing model with suitable simulation parameters including a mesh density of 2,377,000 cells, a time step of 0.005 seconds, a finite number of 18,700 fluid representing particles for fluid A, a finite number of 187,000 fluid representing particles for fluid B. Particle density distributions were calculated for fluid A and fluid B after mixing. The particle density distributions for fluid A and fluid B were converted to the respective spatial distributions of fluid concentration by using the equations (2) and (3) above with α=0.6 mm and r_{c}=1.2 mm. A mixing index for the mixture was calculated based on the spatial distributions for fluid concentration. FIG. 5A illustrates a cross sectional view of the calculated mixing index distribution in a digital 3D model of the static mixer. FIG. 5B illustrates a cross sectional view of the simulated fluid concentration for fluid B in the digital 3D model of the static mixer.

A static mixer prototype was made by 3D printing by using the same CAD file. The particle laden experimental CT-scan after using mixing tip was developed to quantify the detailed mixing process. Copper metal flakes with particle size 325 Mesh (44 microns and finer) was premixed with 3M Scotch-Weld low odor acrylic adhesive DP8810 accelerator part with volume fraction of less than 2%. Then, the mixing experiment of the two-part adhesive using different mixer tips was carried out. After the experiment, the filled mixer tip is CT-scanned using a CT-scan machine commercially available from North Star Imaging (Rogers, Minn.) under the trade designation of X25 Industrial 3D X-Ray Inspection System. Due to the high density of the copper comparing to the adhesive material, the part with the copper particle will show higher density in the CT-scan. FIG. 5C is a cross sectional view of a measured fluid concentration for fluid B from a particle laden experimental CT-scan.

### Example 2: A Dynamic Mixer

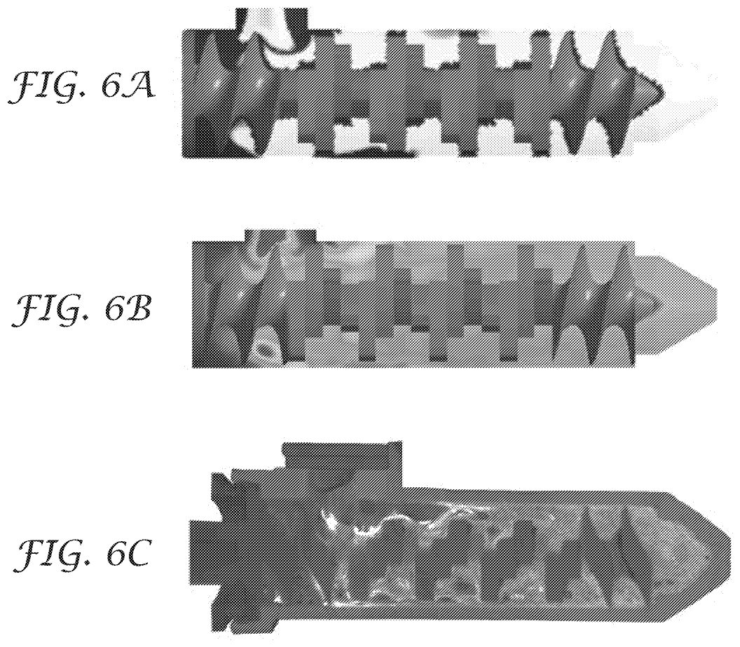

A dynamic mixer was used to validate a computational fluid dynamics (CFD) simulation model. The geometry of the dynamic mixer was created via a CAD file. The CAD file was input to the CFD model for simulation of mixing fluid A and fluid B to form a mixture. Fluids A and B are the same as in Example 1. The CFD model is a particle mixing model with suitable simulation parameters including a mesh density of 2,817,314, a time step of 0.005 seconds, a finite number of 13,800 fluid representing particles for Fluid A, a finite number of 138,000 fluid representing particles for Fluid B. Particle density distributions were calculated for Fluid A and Fluid B after mixing. The particle density distributions for Fluid A and Fluid B were converted to the respective spatial distributions of fluid concentration by using the equations (2) and (3) above with σ=0.6 mm and r_{c}=1.2 mm. A mixing index for the mixture was calculated based on the spatial distributions for fluid concentration. FIG. 6A illustrates a cross sectional view of the calculated mixing index distribution in a digital 3D model of the dynamic mixer. FIG. 6B illustrates a cross sectional view of the simulated fluid concentration for fluid B in the digital 3D model of the dynamic mixer.

A dynamic mixer prototype was made by 3D printing by using the same CAD file as for the simulation. The particle laden experimental CT-scan after using mixing tip was developed to quantify the detailed mixing process. Copper metal flakes with particle size 325 Mesh (44 microns and finer) was premixed with one part of the adhesive with volume fraction of less than 2%. Then, the mixing experiment of the two-part adhesive using different mixer tip was carried out. After the experiment, the filled mixer tip is CT-scanned. Due to the high density of the copper comparing to the adhesive material, the part with the copper particle will show higher density in the CT-scan. FIG. 6C is a cross sectional view of a measured fluid concentration for fluid B from a particle laden experimental CT-scan.

The simulated fluid concentration as visualized in FIG. 6B and the measured fluid concentration as visualized in FIG. 6C were represented by the respective iso-surfaces in the format of polygon surface files. The files were imported to the same coordinate system for visualization using a graphic user interface (GUI) including a computer screen or immersive virtual reality (VR) system. The respective shapes and distributions of the iso-surfaces were compared, where each surface can be displayed or hide using keyboard controls, and the transparence of each surface can be changed to facilitate the comparison. The computational fluid dynamics (CFD) simulation model was validated when the respective shapes and distributions of the iso-surfaces match with each other.

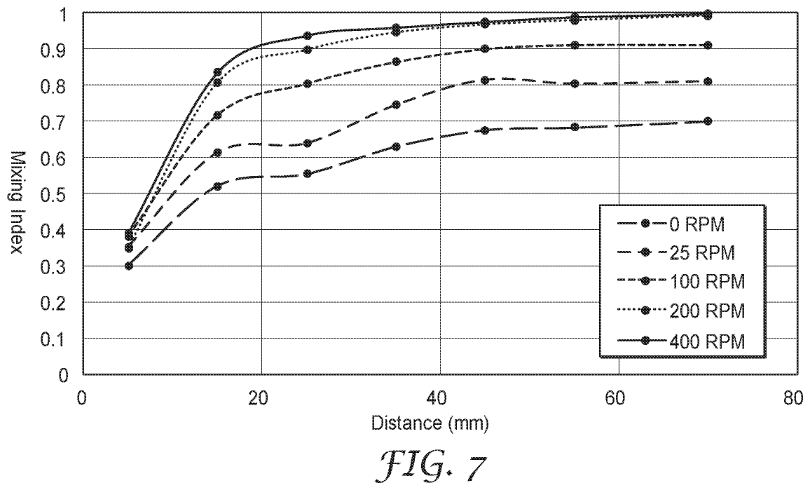

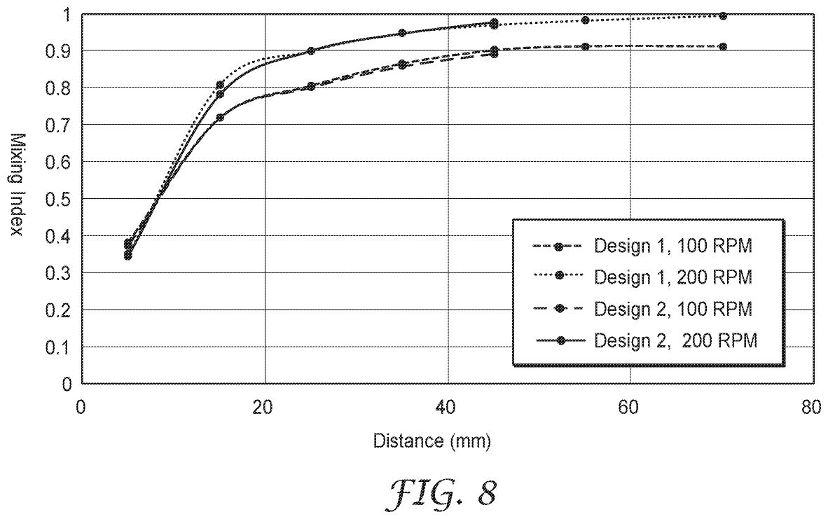

The validated computational fluid dynamics (CFD) simulation model was used to optimize the operation and design of a dynamic mixer. Simulations were performed to output the mixing index along the length of the dynamic mixer for different design and operation conditions. For mixing fluids A and part B for an adhesive, FIG. 7 shows the effects of RPM of a rotating screw inside the dynamic mixer on the mixing index, according the simulation results for the same design of a dynamic mixer. An optimized performance of the dynamic mixer can be achieved when the RPM is about 200. Increasing the RPM from 200 to 400 only slightly increases the value of mixing index. For mixing the same fluids A and B, FIG. 8 shows the mixing index for two different designs 1 and 2 of a dynamic mixer under 100 RPM and 200 RPM. Designs 1 and 2 has similar configurations except that Design 2 has a shorter mixing element than Design 1. According to the simulation, Design 1 has a pressure drop of 120 psi, Design 2 has a pressure drop of 95 psi, and a corresponding static mixer has a pressure drop of 290 psi. Here, the pressure drop refers to the fluid pressure difference between locations at the inlet and the outlet of the respective mixers. FIG. 8 illustrates that the same mixing performance can be achieved with a short length of the mixing element (Design 2 has a shorter mixing element than Design 1), resulting in reducing of waste, power consumption and size. The standard peel and shear experiments were conducted to confirm the performance of optimized mixer in FIG. 8.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

### Listing of Exemplary Embodiments

Exemplary embodiments are listed below. It is to be understood that any one of embodiments 1-19, 20-21 and 22-24 can be combined.

Embodiment 1 is a method of optimizing a mixing tool to mix a plurality of fluid materials to obtain a mixture, the method comprising:

representing a first geometry of the mixing tool with a first digital 3D model;

providing the first digital three-dimensional (3D) model to a computational fluid dynamics (CFD) simulation model implemented by a processor to simulate a mixing process of the plurality of fluids to generate a particle density distribution of the mixture inside the mixing tool;

converting the particle density distribution of the mixture to a first spatial distribution of fluid concentration of the mixture;

measuring a second spatial distribution of fluid concentration of the mixture inside the mixing tool when mixing the plurality of fluids using the mixing tool; and

comparing the first and second spatial distributions of fluid concentration to determine whether the first and second spatial distributions match with each other.

Embodiment 2 is the method of embodiment 1, wherein when the first and second spatial distributions match with each other, the CFD simulation model is validated.
Embodiment 3 is the method of embodiment 2, wherein the first and second spatial distributions are respectively represented by first and second sets of iso-surfaces, and when the respective shapes and distributions of the first and second sets of iso-surfaces match with each other, the CFD simulation model is validated.
Embodiment 4 is the method of embodiment 2 or 3, further comprising optimizing the first geometry of the mixing tool to a second geometry using the validated CFD simulation model.
Embodiment 5 is the method of embodiment 4, further comprising representing the second geometry with a second digital 3D model.
Embodiment 6 is the method of embodiment 5, further comprising providing the second digital 3D model to the validated CFD simulation model to simulate the mixing of the plurality of fluids, and implementing, via the processor, the CFD simulation model to generate an updated particle density distribution of the mixture inside the mixing tool.
Embodiment 7 is the method of embodiment 6, further comprising converting the updated particle density distribution of the mixture to an updated spatial distribution of fluid concentration of the mixture.
Embodiment 8 is the method of embodiment 7, further comprising determining a mixing spatial distribution of index based on the updated spatial distribution of fluid concentration of the mixture.
Embodiment 9 is the method of embodiment 8, further comprising visualizing at least one of the spatial distributions of fluid concentration and mixing index in a graphic user interface to guide a user to determine whether the plurality of fluids is uniformly mixed.
Embodiment 10 is the method of any one of embodiments 1-9, wherein when the first and second spatial distributions do not match with each other, adjusting the CFD simulation model to generate an updated particle density distribution of the mixture.
Embodiment 11 is the method of any one of embodiments 1-10, wherein converting the particle density distribution of the mixture to the first spatial distribution of fluid comprises calculating a fluid concentration at a given point by weighting adjacent discrete fluid representing particles of the particle density distribution.
Embodiment 12 is the method of any one of embodiments 1-11, wherein the comparison comprises visualizing the first and second spatial distributions of fluid concentration, optionally comprising overlaying digital representations of the first and second first and second spatial distributions in a graphic user interface.
Embodiment 13 is the method of embodiment 12, wherein overlaying the digital representations of the first and second first and second spatial distributions comprises importing the corresponding polygon surfaces to the same coordinate system in the graphic user interface.
Embodiment 14 is the method of any one of embodiments 1-13, wherein the mixing of the plurality of fluids via the simulation with the CFD simulation model and via the mixing tool is under the same operation conditions.
Embodiment 15 is the method of embodiment 14, wherein the same operation conditions include the same flow parameters.
Embodiment 16 is the method of any one of embodiments 1-15, wherein the plurality of fluids includes two or more specifies of an adhesive.
Embodiment 17 is the method of any one of embodiments 1-16, wherein the second spatial distribution of fluid concentration is measured via an X-ray scan, optionally including a particle laden experimental CT-scan of the mixing tool.
Embodiment 18 is the method of embodiment 17, wherein copper metal flakes are used for the particle laden experimental CT-scan.
Embodiment 19 is the method of any one of embodiments 1-18, further comprising physically testing the mixture.
Embodiment 20 is a computer-implemented method to visualize a spatial distribution of fluid concentration inside a tool, the method comprising:

representing a first geometry of the tool with a first digital 3D model;

providing the first digital 3D model to a computational fluid dynamics (CFD) simulation model implemented by a processor to simulate a fluid flow inside the tool to generate a particle density distribution of one or more fluids inside the tool;

converting the particle density distribution to a spatial distribution of fluid concentration of the mixture; and

visualizing the spatial distribution of fluid concentration in a graphic user interface (GUI).

Embodiment 21 is the method of embodiment 20, further comprising determining a spatial distribution of mixing index based on the spatial distribution of fluid concentration, and optionally visualizing the spatial distribution of mixing index in a graphic user interface (GUI).
Embodiment 22 is a computer-implemented system to design and optimize a tool, comprising:

a module to represent a first geometry of the tool with a first digital 3D model;

a module to provide the first digital 3D model to a computational fluid dynamics (CFD) simulation model implemented by a processor to simulate a fluid flow inside the tool to generate a particle density distribution of one or more fluids inside the tool;

a module to convert the particle density distribution to a spatial distribution of fluid concentration of the mixture; and

a module to visualize the spatial distribution of fluid concentration and a measured spatial distribution of fluid concentration in a graphic user interface (GUI).

Embodiment 23 is the computer-implemented system of embodiment 22, wherein the module to module to convert the particle density distribution is configured further to determine a spatial distribution of mixing index based on the spatial distribution of fluid concentration.
Embodiment 24 is the computer-implemented system of embodiment 22 or 23, wherein the module to visualize the spatial distribution of fluid concentration is configured further to visualize the spatial distribution of mixing index in a graphic user interface (GUI).

Reference throughout this specification to “one embodiment,” “certain embodiments,” “one or more embodiments,” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment,” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments. While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. Furthermore, various exemplary embodiments have been described. These and other embodiments are within the scope of the following claims.

1. A method of designing and optimizing a mixing tool to mix a plurality of fluid materials to obtain a mixture, the method comprising:
representing a first geometry of the mixing tool with a first digital 3D model;
providing the first digital three-dimensional (3D) model to a computational fluid dynamics (CFD) simulation model implemented by a processor to simulate a mixing process of the plurality of fluids to generate a particle density distribution of the mixture inside the mixing tool;
converting the particle density distribution of the mixture to a first spatial distribution of fluid concentration of the mixture;
measuring a second spatial distribution of fluid concentration of the mixture inside the mixing tool when mixing the plurality of fluids using the mixing tool; and
comparing the first and second spatial distributions of fluid concentration to determine whether the first and second spatial distributions match with each other.

2. The method of claim 1, wherein when the first and second spatial distributions match with each other, the CFD simulation model is validated.

3. The method of claim 2, wherein the first and second spatial distributions are respectively represented by first and second sets of iso-surfaces, and when the respective shapes and distributions of the first and second sets of iso-surfaces match with each other, the CFD simulation model is validated.

4. The method of claim 2, further comprising optimizing the first geometry of the mixing tool to a second geometry using the validated CFD simulation model.

5. The method of claim 4, further comprising representing the second geometry with a second digital 3D model.

6. The method of claim 5, further comprising providing the second digital 3D model to the validated CFD simulation model to simulate the mixing of the plurality of fluids, and implementing, via the processor, the CFD simulation model to generate an updated particle density distribution of the mixture inside the mixing tool.

7. The method of claim 6, further comprising converting the updated particle density distribution of the mixture to an updated spatial distribution of fluid concentration of the mixture.

8. The method of claim 7, further comprising determining a spatial distribution of mixing index based on the updated spatial distribution of fluid concentration of the mixture.

9. The method of claim 8, further comprising visualizing at least one of the spatial distributions of fluid concentration and mixing index in a graphic user interface (GUI) to guide a user to determine whether the plurality of fluids is uniformly mixed.

10. The method of claim 1, wherein when the first and second spatial distributions do not match with each other, adjusting the CFD simulation model to generate an updated particle density distribution of the mixture.

11. The method of claim 1, wherein converting the particle density distribution of the mixture to the first spatial distribution of fluid comprises calculating a fluid concentration at a given point by weighting adjacent discrete fluid representing particles of the particle density distribution.

12. The method of claim 1, wherein comparing the first and second spatial distributions comprises visualizing the first and second spatial distributions of fluid concentration in a graphic user interface.

13. The method of claim 12, wherein the visualizing further comprises overlaying digital representations of the first and second first and second spatial distributions in a graphic user interface.

14. The method of claim 13, wherein overlaying the digital representations of the first and second first and second spatial distributions comprises importing the corresponding polygon surfaces to the same coordinate system in the graphic user interface.

15. The method of claim 1, wherein the mixing of the plurality of fluids via the simulation with the CFD simulation model and via the mixing tool is under the same operation conditions.

16. The method of claim 1, wherein the plurality of fluids includes two or more specifies of an adhesive.

17. The method of claim 1, wherein the second spatial distribution of fluid concentration is measured via an X-ray scan of the mixing tool.

18. A computer-implemented method to design and optimize a tool, the method comprising:
representing a first geometry of the tool with a first digital three-dimensional (3D) model;
providing the first digital 3D model to a computational fluid dynamics (CFD) simulation model implemented by a processor to simulate a fluid flow inside the tool to generate a particle density distribution of one or more fluids inside the tool;
converting the particle density distribution to a spatial distribution of fluid concentration of the mixture; and
visualizing the spatial distribution of fluid concentration and a measured spatial distribution of fluid concentration in a graphic user interface (GUI).

19. The method of claim 18, further comprising determining a spatial distribution of mixing index based on the spatial distribution of fluid concentration, and visualizing the spatial distribution of mixing index in the graphic user interface (GUI).

20. A computer-implemented system to design and optimize a tool, comprising:
a module to represent a first geometry of the tool with a first digital three-dimensional (3D) model;
a module to provide the first digital 3D model to a computational fluid dynamics (CFD) simulation model implemented by a processor to simulate a fluid flow inside the tool to generate a particle density distribution of one or more fluids inside the tool;
a module to convert the particle density distribution to a spatial distribution of fluid concentration of the mixture; and
a module to visualize the spatial distribution of fluid concentration and a measured spatial distribution of fluid concentration in a graphic user interface (GUI).

21-22. (canceled)
